(19) United States
(12) Patent Application Publication
(10) Pub. No.: US 2015/0106433 A1
(43) Pub. Date: Apr. 16, 2015

(54) DATA TRANSMISSION METHOD, SYSTEM AND STORAGE MEDIUM THREROF

(71) Applicants: Delta Networks (Xiamen) LTD., Xiamen (CN); Delta Networks, Inc., Taoyuan County (TW)

(72) Inventors: Bin ZHAO, Xiamen (CN); ChunWei LIU, Xiamen (CN); Min LU, Xiamen (CN); ChangFa XU, Xiamen (CN); XiaoWei CHEN, Xiamen (CN)

(21) Appl. No.: 14/481,580

(22) Filed: Sep. 9, 2014

(30) Foreign Application Priority Data
Oct. 16, 2013 (CN) 201310485986.1

(51) Int. Cl. H04L 29/12; H04L 12/26; H04L 29/06

(52) U.S. Cl. CPC H04L 61/2589; H04L 67/42; H04L 43/16
USPC 709/203

(57) ABSTRACT

A data transmission method is provided. The method includes: establishing, by a first NAT-T sub-module of a TCP server proxy module, a transmission channel with a second NAT-T sub-module of a TCP client proxy module via a NAT-T signal server; and transmitting, by a client, a data packet to a server module in the transmission channel via the TCP server proxy module and the TCP client proxy module; wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

### CROSS REFERENCE TO RELATED APPLICATIONS

This application claims priority of China Patent Application No. 201310485986.1, filed on Oct. 16, 2013, the entirety of which is incorporated by reference herein.

### BACKGROUND OF THE INVENTION

1. Field of the Invention

The present invention relates to a data transmission method, system and storage medium thereof, and in particular to a data transmission method, system and storage medium thereof used to transmit a TCP (Transmission Control Protocol) data packet.

2. Description of the Related Art

In recent years, with the development of Internet bandwidth access technology, more and more devices may access the Internet, such as network TVs, lights, air conditioners, refrigerators, network cameras and other device. Network devices bring convenience and practicality to users, and have been widely used in houses, communities, businesses and office buildings among other places.

When performing TCP peer-to-peer communication, a traditional network device needs to be assigned a unique public network IP address by the user, and the network device needs to configure the corresponding network configuration. However, in recent years, the number of network devices which can access the Internet has increased rapidly and the number of available public network IP addresses has reduced gradually. Therefore, it is necessary to deploy the network devices to a local area network (LAN) to reduce the usage of the public network IP addresses. However, traditional TCP network devices located in different LANs cannot directly perform peer-to-peer communication. Although the network address translation (NAT) technology can be used to perform peer-to-peer communication, the success rate of network address translation technology based on TCP is poor. Thus, these complicated situations described above are limited to the applications and developments of the network devices.

Therefore, how to directly perform TCP peer-to-peer communication between devices having private network IP addresses in different LANs becomes an urgent problem.

### BRIEF SUMMARY OF THE INVENTION

A detailed description is given in the following embodiments with reference to the accompanying drawings.

A data transmission method, system and storage medium thereof are provided.

In one exemplary embodiment, the invention is directed to a data transmission system. The data transmission system comprises a client, a TCP (Transmission Control Protocol) server proxy module, a server, a TCP client proxy module and a NAT-T signal server. The client comprises a client module, and the client module is configured to transmit a data packet. The TCP server proxy module comprises a first NAT-T (Network address translation traversal) sub-module and a first reliable transmission sub-module connected to the first NAT-T sub-module. The server comprises a server module, and the server module is configured to receive the data packet. The TCP client proxy module is connected to the server module and comprises a second NAT-T sub-module and a second reliable transmission sub-module connected to the second NAT-T sub-module. The NAT-T signal server is connected to the first NAT-T sub-module and the NAT-T sub-module via a network. The first NAT-T sub-module establishes a transmission channel with the second NAT-T sub-module via the NAT-T signal server. The client device transmits the data packet to the server module in the transmission channel via the TCP server proxy module and the TCP client proxy module. When the first reliable transmission sub-module and the second reliable transmission sub-module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

In one exemplary embodiment, the invention is directed to a establishing, by a first NAT-T (Network address translation traversal) sub-module of a TCP (Transmission Control Protocol) server proxy module, a transmission channel with a second NAT-T sub-module of a TCP client proxy module via a NAT-T signal server; and transmitting, by a client, a data packet to a server module in the transmission channel via the TCP server proxy module and the TCP client proxy module; wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

In one exemplary embodiment, the invention is directed to a non-transitory computer-readable storage medium comprising computer programs, which, when executed, causes a system to perform a data transmission method, the method comprising: establishing, by a first NAT-T (Network address translation traversal) sub-module of a TCP (Transmission Control Protocol) server proxy module, a transmission channel with a second NAT-T sub-module of a TCP client proxy module via a NAT-T signal server; and transmitting, by a client, a data packet to a server module in the transmission channel via the TCP server proxy module and the TCP client proxy module, wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

### BRIEF DESCRIPTION OF THE DRAWINGS

The present invention can be more fully understood by reading the subsequent detailed description and examples with references made to the accompanying drawings, wherein:

FIG. 1 is a schematic diagram of a data transmission system according to an embodiment of the present invention.

FIG. 2 is a schematic diagram illustrating the TCP client proxy module being installed in the server and the TCP server proxy module being installed in the client according to an embodiment of the present invention.

FIG. 3 is a schematic diagram illustrating the TCP client proxy module and the TCP server proxy module being installed in the router according to an embodiment of the present invention.

FIG. 4 is a block diagram of a reliable transmission sub-module 400 according to an embodiment of the present invention

FIG. 5 is a flow diagram illustrating a data transmission method according to an embodiment of the present invention.

FIGS. 6A˜6C are message flows illustrating how the transmission channel is established and the data is transmitted between the client and the server according to an embodiment of the present invention.

### DETAILED DESCRIPTION OF THE INVENTION

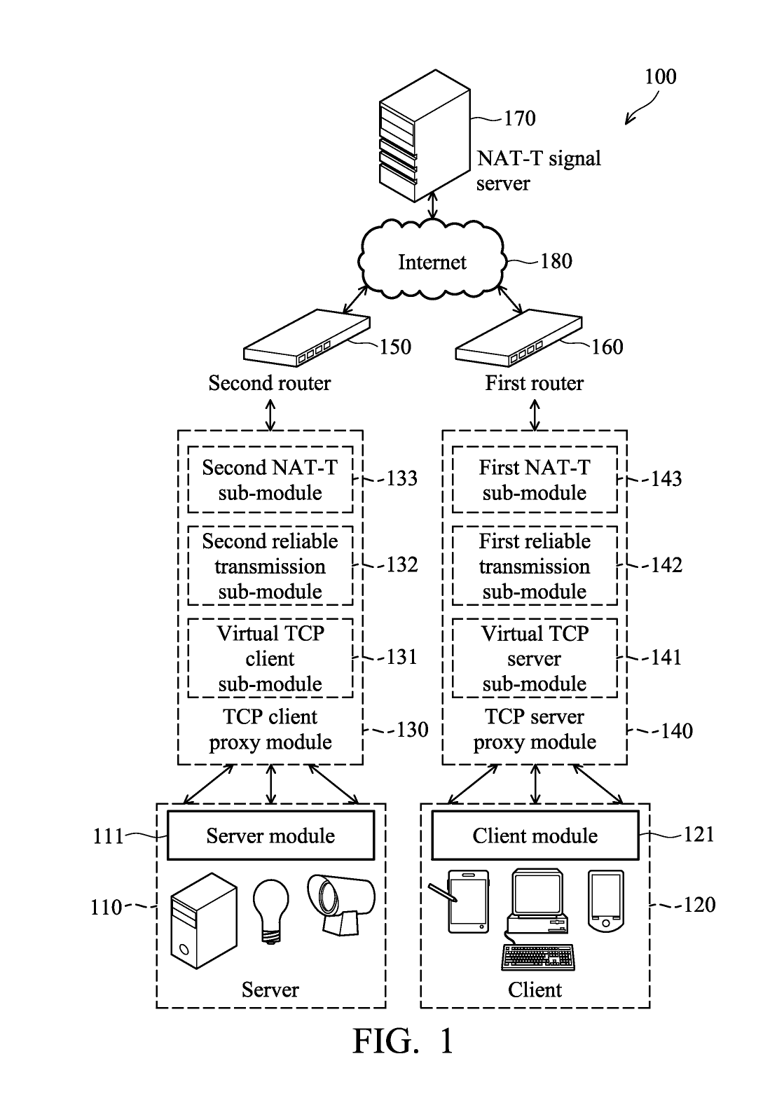

Several exemplary embodiments of the application are described with reference to FIGS. 1 through 6C, which generally relate to navigation of a data transmission method, system, and storage medium thereof used to transmit a TCP (Transmission Control Protocol) data packet. It should be understood that the following disclosure provides various different embodiments as examples for implementing different features of the application. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 1 is a schematic diagram of a data transmission system 100 according to an embodiment of the present invention. The data transmission system 100 at least comprises a server 110 and a client 120, a first router 160, a second router 150, a NAT-T (Network address translation traversal) signal server 170, a TCP (Transmission Control Protocol) client proxy module 130, and a TCP server proxy module 140. It should be noted that the number of clients, servers, routers and so on in the invention is not limited.

The client 120 is used to transmit a data packet, and comprises a client module 121. The client 120 can be any electronic device with network connection capacity based on TCP (Transmission Control Protocol), for example, tablets, personal computers, mobile phones and other electronic devices connected to the Internet 180.

The server 110 is used to receive the data packet, and comprises a server module 111. The server 110 can be network devices or servers with network connection capacity based on any TCP. For example, the server 110 can be a network television, light, air conditioner, refrigerator, camera or another network device that can be connected to the Internet 180.

The TCP server proxy module 140 may comprise a virtual TCP server sub-module 141, a first reliable transmission sub-module 142 and a first NAT-T sub-module 143, wherein the virtual TCP server sub-module 141 is connected to the first reliable transmission sub-module 142 and the client module 121, and the first reliable transmission sub-module 142 is connected to the virtual TCP server sub-module 141 and the first NAT-T sub-module 143. It should be noted that the data transmission system 100 may comprise one or more servers 110 and TCP server proxy modules 140, and the TCP server proxy modules 140 have respective identities (ID) providing uniqueness. In this embodiment, the TCP server proxy modules 140 has first ID information and first Internet-address information.

The TCP client proxy module 130 may comprise a virtual TCP client sub-module 131, a second reliable transmission sub-module 132 and a second NAT-T sub-module 133, wherein the virtual TCP client sub-module 131 is connected to the second reliable transmission sub-module 132 and the server module 111, and the second reliable transmission sub-module 132 is connected to the virtual TCP client sub-module 131 and the second NAT-T sub-module 133. It should be noted that the data transmission system 100 may comprise one or more clients 120 and TCP client proxy modules 130, and the TCP client proxy modules 130 have respective identities (ID) proving the uniqueness. In this embodiment, the TCP client proxy modules 130 have second ID information and a second Internet-address information. In addition, the virtual TCP server sub-module 141 may forward the data packet between the first reliable transmission sub-module 142 and the client module 121. Similarly, the virtual TCP client sub-module 131 may forward the data packet between the second reliable transmission sub-module 132 and the server module 111.

The NAT-T signal server 170 is connected to the first router 160 and the second router 150 through the Internet 180, and can be used to provide the server 110 and the client 120 with a network address translation service.

First, a first NAT-T sub-module 143 establishes a transmission channel via the NAT-T signal server 170 and the second NAT-T sub-module 133. Next, the client module 121 transmits the data packet to the server module 111 in the transmission channel via the TCP server proxy module 140 and the TCP client proxy module 130, wherein when the first reliable transmission sub-module 142 and the second reliable transmission sub-module 132 receive the data packet, the first reliable transmission sub-module 142 and the second reliable transmission sub-module 132 detect the transmission channel and the data packet, and control the transmission channel and the data packet suitably according to a detection result so that the data packet can be forwarded between the client module 121 and the server module 111 reliably.

It should be noted that the data packet is a TCP data packet, and the data transmission system 100 supports TCP. The first NAT-T sub-module 143 and the second NAT-T sub-module 133 use user datagram protocol (UDP) communication, and therefore the data packet transmitted by the first NAT-T sub-module 143 and the second NAT-T sub-module 144 belongs to the UDP data packet.

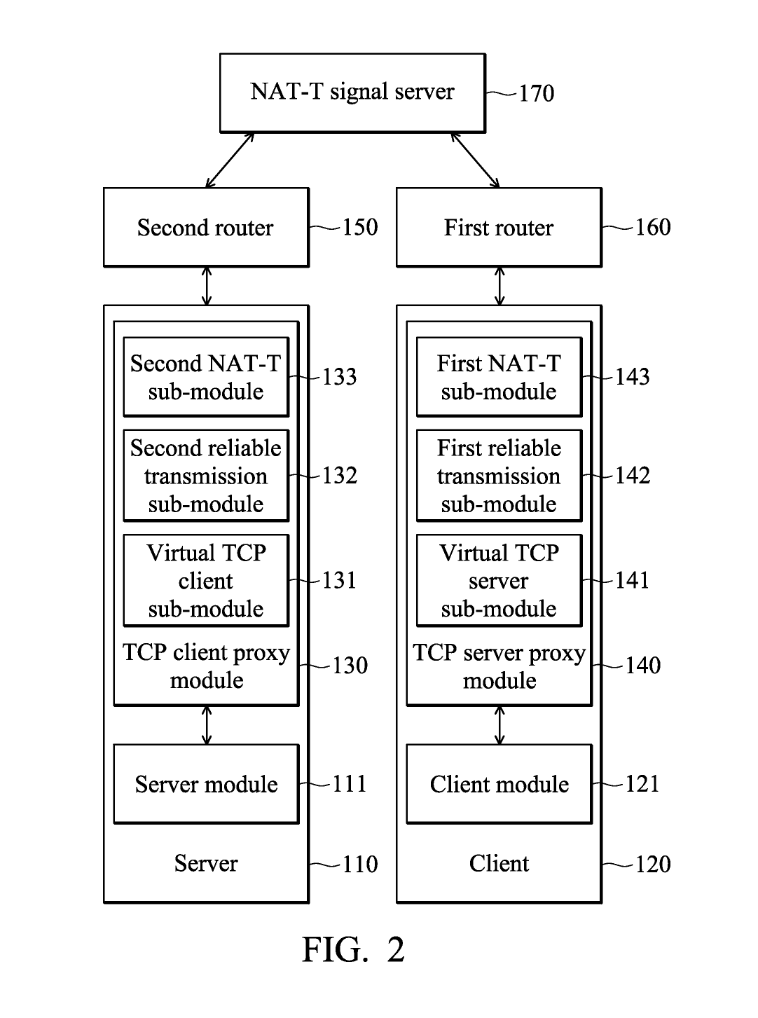

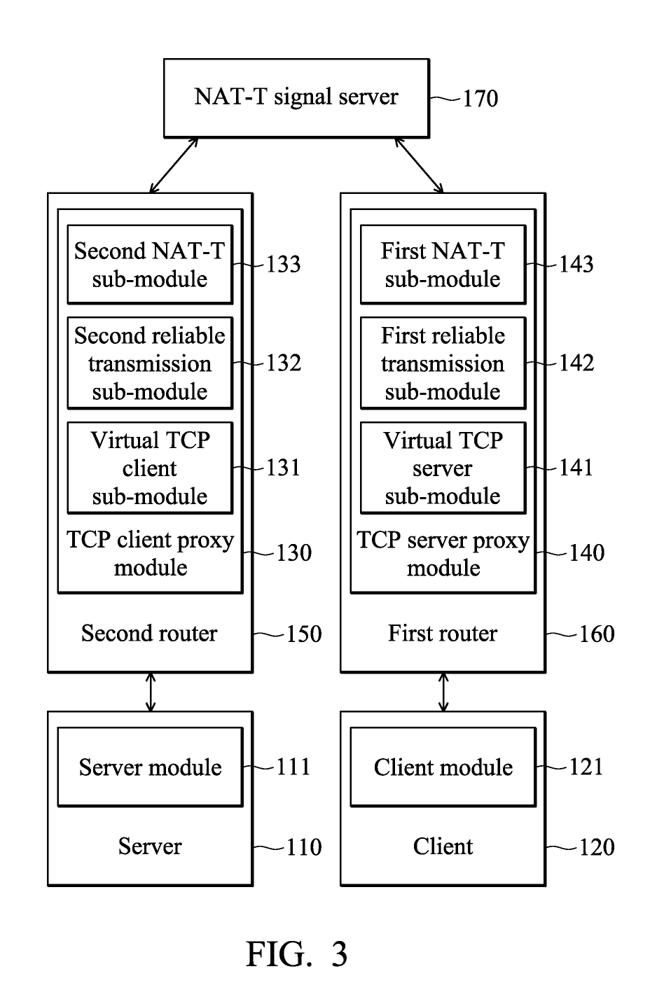

In one embodiment, the TCP client proxy module 130 can be installed in the server 110, and the TCP proxy server module 140 can be installed in the client 120, as shown in FIG. 2. Using this method, it is easy to connect the server 110 with the network used by the client 120, and this method does not add other network equipment. Furthermore, in another embodiment, the TCP client proxy module 130 may be also installed in the second router 150, and the TCP server proxy module 140 may be installed in the first router 160, as shown in FIG. 3. Using this method in FIG. 3 does not need to install the TCP client proxy module 130 and the TCP server proxy module 140 in the server 110 and the client 120 respectively, and allow the client 120 to directly perform a peer-to-peer remote access procedure with an existing server 110.

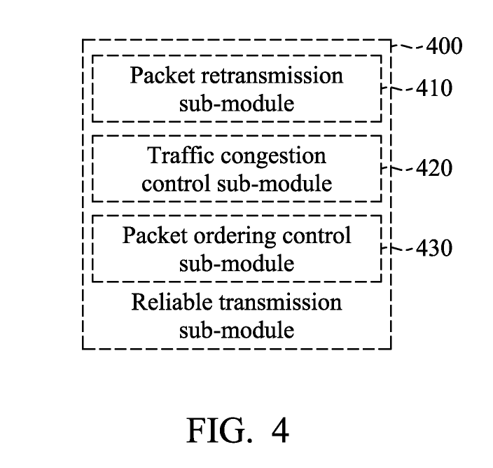

FIG. 4 is a block diagram of a reliable transmission sub-module 400 according to an embodiment of the present invention. The first reliable transmission sub-module 142 and the second reliable transmission sub-module 132 have the same structure, and both can be represented by the reliable transmission sub-module 400 shown in FIG. 4. The reliable transmission sub-module 400 comprises a packet retransmission sub-module 410, a traffic congestion control sub-module 420 and a packet ordering control sub-module 430. The packet retransmission sub-module 410 is used to detect whether the data packet is lost. When the data packet is lost, the packet retransmission sub-module 410 retransmits the data packet. The traffic congestion control sub-module 420 is connected to the packet retransmission sub-module 410 and is used to detect and evaluate a network performance of the transmission channel, wherein the network performance may be a number of transmitting data packets. When the number of transmitting data packets in the network exceeds a threshold (i.e., there are too many data packets in the network), the network performance will be decreased. The traffic congestion control sub-module 420 may decrease a transmission rate of transmitting the data packets and reduce the number of data packets to avoid network congestion. The packet ordering control sub-module 430 is connected to the traffic congestion control sub-module 420, and is used to detect whether a receiving sequence of the data packets is consistent with a transmitting sequence of the data packets. When detecting the receiving sequence of the data packets is not consistent with the transmitting sequence of the data packets, the packet ordering control sub-module 430 adjusts the transmitting sequence so that it is consistent with the receiving sequence.

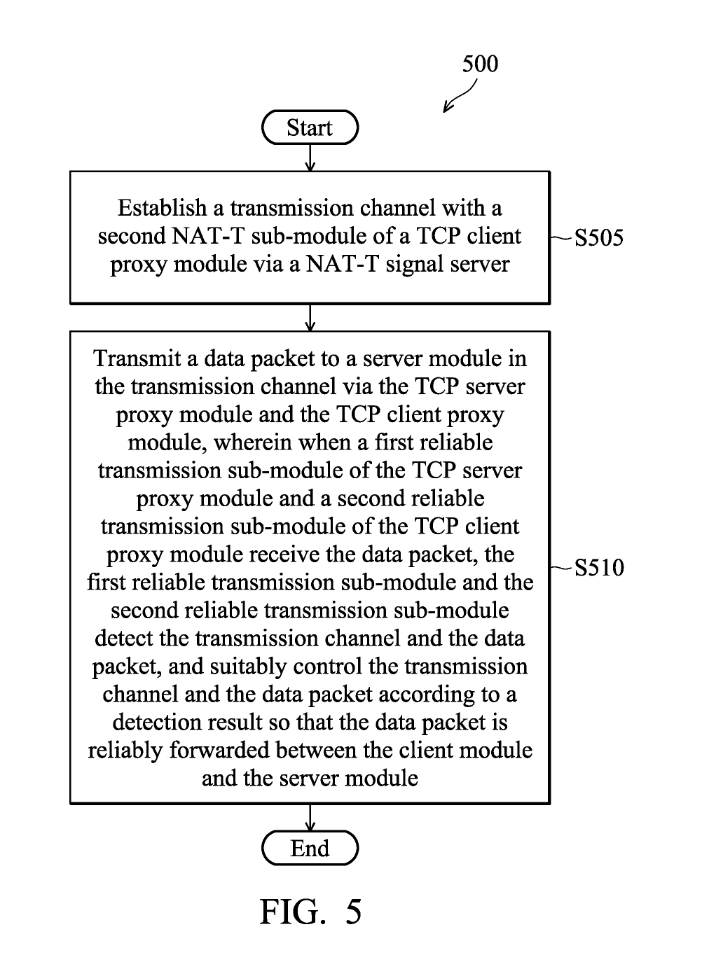

FIG. 5 is a flow diagram 500 illustrating a data transmission method according to an embodiment of the present invention. In step S505, a first NAT-T sub-module of a TCP server proxy module establishes a transmission channel with a second NAT-T sub-module of a TCP client proxy module via a NAT-T signal server. Next, in step S510, a client transmits a data packet to a server module in the transmission channel via the TCP server proxy module and the TCP client proxy module, wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and control the transmission channel and the data packet suitably according to a detection result so that the data packet is forwarded between the client module and the server module reliably.

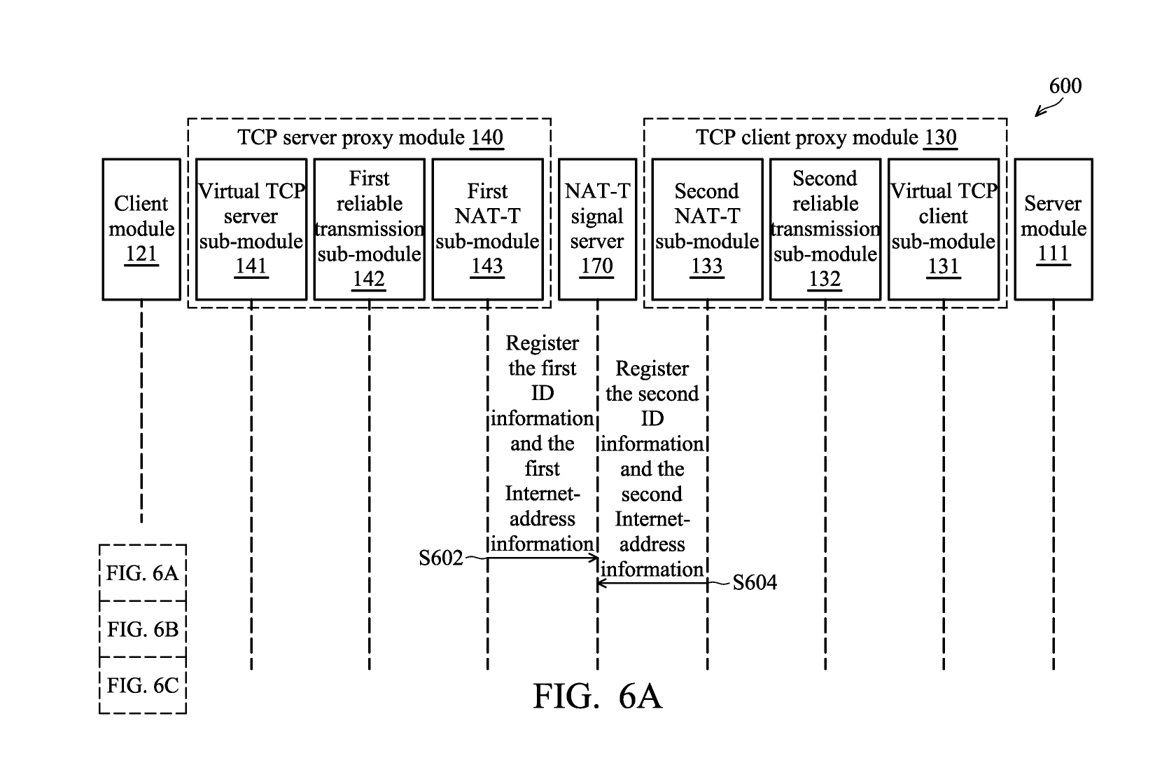

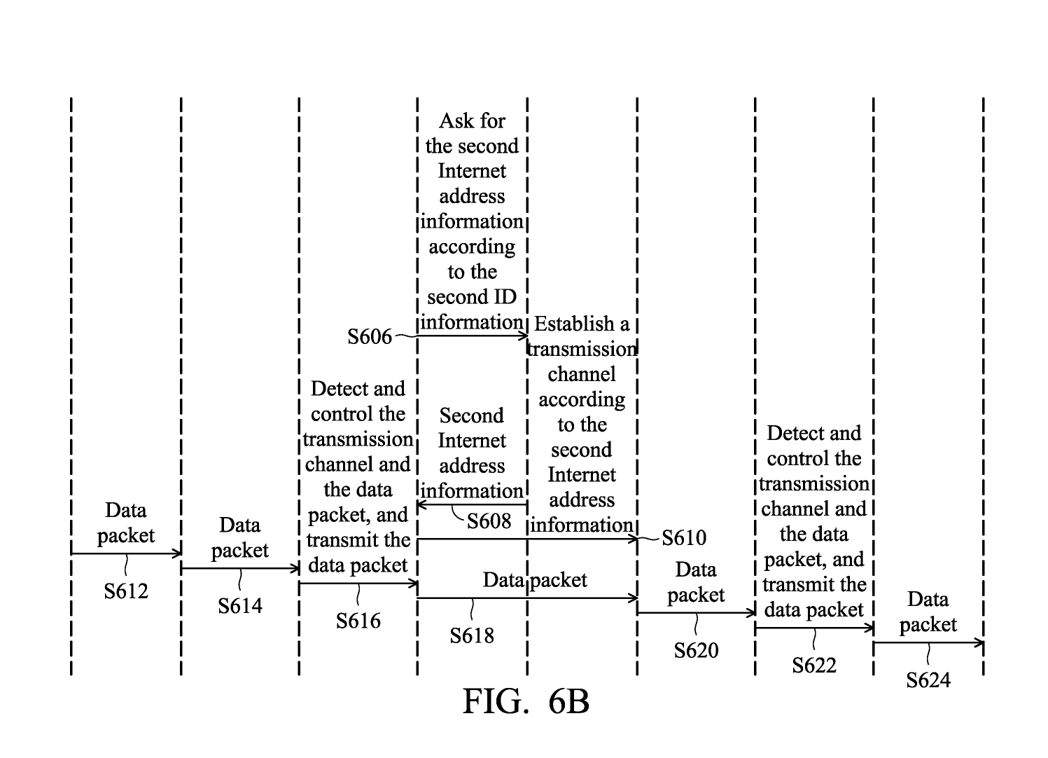

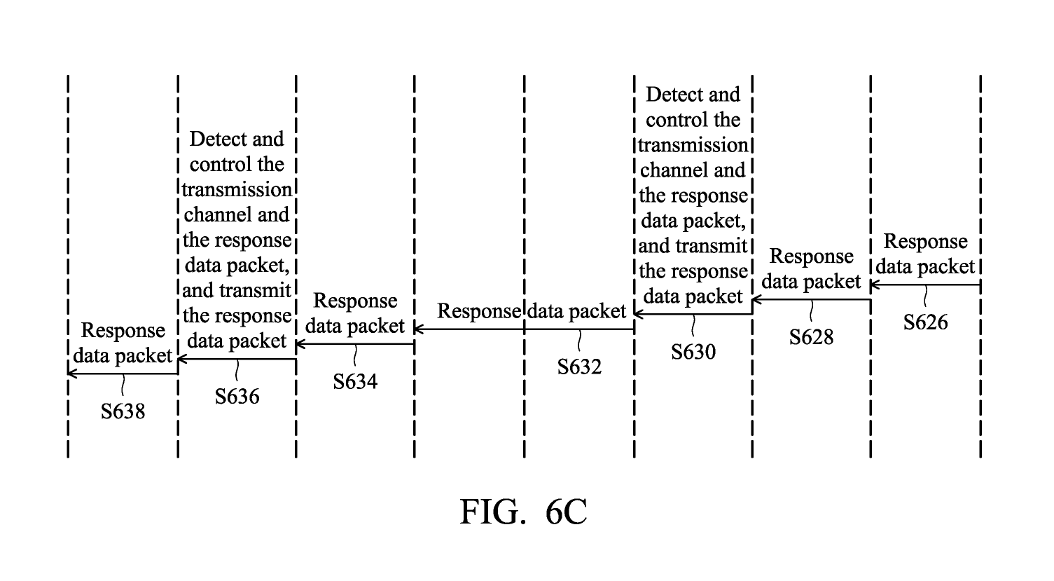

FIGS. 6A˜6C are message flows illustrating how the transmission channel is established and the data is transmitted between the client and the server according to an embodiment of the present invention with the reference to FIGS. 1˜3. In step S602, after the TCP server proxy module 140 is connected to the network, the first NAT-T sub-module 143 registers the first ID information and the first Internet-address information of the TCP server proxy module 140 with the NAT-T signal server 170. In step S604, after the TCP client proxy module 130 is connected to the network, the second NAT-T sub-module 133 registers the second ID information and the second Internet-address information of the TCP client module 130 with the NAT-T signal server 170. It should be noted that, in this embodiment, the sequence of step S602 and step S604 can be reversed or step S602 and step S604 can be performed simultaneously, and the sequence is not limited to this embodiment.

In step S606, the first NAT-T sub-module 143 asks the NAT-T signal server 170 the second Internet-address information according to the second ID information of the TCP client module 130. In step S608, the NAT-T signal server 170 transmits the second Internet-address information corresponding to the second ID information of the TCP client module 130 to the TCP server proxy module 140, and then the first NAT-T sub-module 143 receives the second Internet-address information. In step S610, the first NAT-T sub-module 143 establishes a transmission channel according to the second Internet-address information of the second NAT-T sub-module 133.

Then, in step S612, the client module 121 transmits a data packet to the virtual TCP server sub-module 141. In step S614, the virtual TCP server sub-module 141 forwards the data packet to the first reliable transmission sub-module 142. In step S616, the first reliable transmission sub-module 142 detects and controls the transmission channel and the data packet, and transmits the data packet to the first NAT-T sub-module 143. In step S618, the first NAT-T sub-module 143 forwards the data packet to the second NAT-T sub-module 133. In step S620, the second NAT-T sub-module 133 forwards the data packet to the second reliable transmission sub-module 132. In step S622, the second reliable transmission sub-module 132 detects and controls the transmission channel and the data packet, and transmits the data packet to the virtual TCP client sub-module 131. In step S624, the virtual TCP client sub-module 131 forwards the data packet to the server module 111.

After the server module 111 receives the data packet, in step S626, the server module 11 generates a response data packet and transmits the response data packet to the virtual TCP client sub-module 131 of the TCP client module 130. After receiving the response data packet, in step S628, the virtual TCP client sub-module 131 forwards the response data packet to the second reliable transmission sub-module 132. In step S630, the second reliable transmission sub-module 132 detects and controls the transmission channel and the response data packet, and transmits the response data packet to the second NAT-T sub-module 133. In step S632, the second NAT-T sub-module 133 forwards the response data packet to the first NAT-T sub-module 143. In step S634, the first NAT-T sub-module 143 forwards the response data packet to the first reliable transmission sub-module 142. In step S636, the first reliable transmission sub-module 142 detects and controls the transmission channel and the response data packet, and transmits the virtual TCP server sub-module 141. Finally, after receiving the response data packet, in step S638, the virtual TCP server sub-module 141 forwards the response data packet to the client module 121 of the client to finish the transmission.

Therefore, the data transmission method, system and storage medium thereof are suitable for any network device that supports the TCP application protocol and are suitable for any IP-based network and are not limited to a heterogeneous network or system. In addition, because the NAT-T technology is used in the present invention, the TCP client and the server can communicate directly with each other to reduce the load on the server. Furthermore, when the data packet is lost in the UDP communication, the lost packet can be retransmitted by using the reliable transmission sub-module in the present invention. The reliable transmission sub-module of the present invention can further control the transmission flow and the sequence of the data packets to ensure that the transmitting sequence is consistent with the receiving sequence of the data packets when the transmission flow is large between the proxy modules.

The data transmission method, system and storage medium thereof or any forms for carrying out the method, or any parts thereof may be implemented in a computer program, wherein the computer program may be stored in any machine-readable storage medium, such as a floppy disc, hard disc, optical disc, or computer program product with any external form. In particularly, when the computer program is loaded into and executed by an electronic device, e.g., a computer, the electronic device becomes an apparatus or system for performing the steps of the data transmission method. Alternatively, the computer program may be transferred via certain transferring media, such as electric wires/cables, optical fibers, or other media.

Correspondingly, the invention also proposes a machine-readable storage medium comprising a computer program, which, when executed, causes an electronic device to perform the data transmission method. The steps of the method are as described above with respect to FIGS. 5-6C and, thus, a detailed description of the method is omitted here for brevity.

Various aspects of the disclosure have been described above. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, processors, means, circuits, and algorithm steps described in connection with the aspects disclosed herein may be implemented as electronic hardware (e.g., a digital implementation, as an analog implementation, or as a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware component, electrical component, optical component, mechanical component, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data transmission system, comprising:
a client, comprising:
a client module, configured to transmit a data packet;
a TCP (Transmission Control Protocol) server proxy module, comprising:
a first NAT-T (Network address translation traversal) sub-module; and
a first reliable transmission sub-module, connected to the first NAT-T sub-module;
a server, comprising:
a server module, configured to receive the data packet;
a TCP client proxy module, connected to the server module, comprising:
a second NAT-T sub-module; and
a second reliable transmission sub-module, connected to the second NAT-T sub-module; and
a NAT-T signal server, connected to the first NAT-T sub-module and the NAT-T sub-module via a network;
wherein the first NAT-T sub-module establishes a transmission channel with the second NAT-T sub-module via the NAT-T signal server;
wherein the client device transmits the data packet to the server module in the transmission channel via the TCP server proxy module and the TCP client proxy module;
wherein when the first reliable transmission sub-module and the second reliable transmission sub-module receive the data packet, the first reliable transmission sub-module and the second reliable transmission sub-module detect the transmission channel and the data packet, and suitably control the transmission channel and the data packet suitably according to a detection result so that the data packet is reliably forwarded between the client module and the server module.

2. The data transmission system as claimed in claim 1, wherein the server proxy module has first ID information and first Internet-address information, and the client proxy module has second ID information and second Internet-address information; while the step of establishing the transmission channel by the first NAT-T sub-module via the NAT-T signal server and the second NAT-T sub-module further comprises, the first NAT-T sub-module registers the first ID information and the first Internet-address information with the NAT-T signal server, and the client proxy module registers the second ID information and the second Internet-address information with the NAT-T signal server via the second NAT-T sub-module; the first NAT-T sub-module obtains the second Internet-address information from the NAT-T signal server according to the second ID information; after obtaining the second Internet-address information, the first NAT-T sub-module establishes the transmission channel with the second NAT-T sub-module according to the second Internet-address information.

3. The data transmission system as claimed in claim 1, wherein the first reliable transmission sub-module and the second reliable transmission sub-module further respectively comprise:
a packet retransmission sub-module, configured to detect whether the data packet is lost, and retransmit the data packet when the data packet is lost;
a traffic congestion control sub-module, connected to the packet retransmission sub-module and configured to detect a network performance of the transmission channel; wherein the network performance is a number of transmitting data packets, wherein when the number of transmitting the data packets in the network exceeds a threshold, the traffic congestion control sub-module decreases a transmission rate of transmitting the data packets and reduces the number of data packets to avoid network congestion; and
a packet ordering control sub-module, connected to the traffic congestion control sub-module and configured to detect whether a receiving sequence of the data packets is consistent with a transmitting sequence of the data packets, wherein when detecting the receiving sequence of the data packets is not consistent with the transmitting sequence of the data packets, the packet ordering control sub-module adjusts the transmitting sequence so that it is consistent with the receiving sequence.

4. The data transmission system as claimed in claim 1, wherein the TCP server proxy module further comprises a virtual TCP server sub-module, connected to the first reliable transmission sub-module and the client module and configured to forward the data packet between the first reliable transmission sub-module and the client module; and the TCP client proxy module further comprises a virtual TCP client sub-module, connected to the second reliable transmission sub-module and the server module and configured to forward the data packet between the second reliable transmission sub-module and the server module.

5. The data transmission system as claimed in claim 1, further comprising:
a first router, connected to the client and configured to connect the client with the network; and
a second router, connected to the server and configured to connect the server with the network.

6. The data transmission system as claimed in claim 1, wherein the data packet is a TCP data packet.

7. The data transmission system as claimed in claim 1, wherein the system supports TCP.

8. A data transmission method, comprising:
establishing, by a first NAT-T (Network address translation traversal) sub-module of a TCP (Transmission Control Protocol) server proxy module, a transmission channel with a second NAT-T sub-module of a TCP client proxy module via a NAT-T signal server; and
transmitting, by a client, a data packet to a server module in the transmission channel via the TCP server proxy module and the TCP client proxy module;
wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

9. The data transmission method as claimed in claim 8, wherein the server proxy module has first ID information and first Internet-address information, and the client proxy module has second ID information and second Internet-address information; while the step of establishing the transmission channel by the first NAT-T sub-module via the NAT-T signal server and the second NAT-T sub-module further comprises the steps of:
registering, by the first NAT-T sub-module, the first ID information and the first Internet-address information with the NAT-T signal server, and registering, by the client proxy module, the second ID information and the second Internet-address information with the NAT-T signal server via the second NAT-T sub-module;
obtaining, by the first NAT-T sub-module, the second Internet-address information from the NAT-T signal server according to the second ID information; and
establishing, by the first NAT-T sub-module, the transmission channel with the second NAT-T sub-module according to the second Internet-address information after obtaining the second Internet-address information.

10. The data transmission method as claimed in claim 8, wherein the step of detecting the transmission channel and the data packet by the first reliable transmission sub-module and the second reliable transmission sub-module further comprises the steps:
detecting, by a packet retransmission sub-module, whether the data packet is lost, and retransmitting the data packet when the data packet is lost;
detecting, by a traffic congestion control sub-module, a network performance of the transmission channel; wherein the network performance is a number of transmitting data packets, when the number of transmitting the data packets in the network exceeds a threshold, the traffic congestion control sub-module decreases a transmission rate of transmitting the data packets and reduces the number of data packets to avoid network congestion; and
detecting, by a packet ordering control sub-module, whether a receiving sequence of the data packets is consistent with a transmitting sequence of the data packets; when detecting the receiving sequence of the data packets is not consistent with the transmitting sequence of the data packets, the packet ordering control sub-module adjusts the transmitting sequence so that it is consistent with the receiving sequence.

11. The data transmission method as claimed in claim 8, further comprising:
forwarding, by a virtual TCP server sub-module of the TCP server proxy module, the data packet between the first reliable transmission sub-module and the client module; and
forwarding, by a virtual TCP client sub-module of the TCP client proxy module, the data packet between the second reliable transmission sub-module and the server module.

12. The data transmission method as claimed in claim 8, further comprising:
connecting, by a first router, the client with the network; and
connecting, by a second router, the server with the network.

13. The data transmission method as claimed in claim 8, wherein the data packet is a TCP data packet.

14. The data transmission method as claimed in claim 8, wherein the system supports TCP.

15. A non-transitory computer-readable storage medium comprising computer programs, which, when executed, causes a system to perform a data transmission method, the method comprising:
establishing, by a first NAT-T (Network address translation traversal) sub-module of a TCP (Transmission Control Protocol) server proxy module, a transmission channel with a second NAT-T sub-module of a TCP client proxy module via a NAT-T signal server; and
transmitting, by a client, a data packet to a server module in the transmission channel via the TCP server proxy module and the TCP client proxy module,
wherein when a first reliable transmission sub-module of the TCP server proxy module and a second reliable transmission sub-module of the TCP client proxy module receive the data packet, the first reliable transmission sub-module and the second reliable transmission sub-module detect the transmission channel and the data packet, and suitably control the transmission channel and the data packet according to a detection result so that the data packet is reliably forwarded between the client module and the server module.

16. The non-transitory computer-readable storage medium as claimed in claim 15, wherein the server proxy module has first ID information and first Internet-address information, and the client proxy module has second ID information and second Internet-address information; while the step of establishing the transmission channel by the first NAT-T sub-module via the NAT-T signal server and the second NAT-T sub-module further comprises:
registering, by the first NAT-T sub-module, the first ID information and the first Internet-address information with the NAT-T signal server, and registering, by the client proxy module, the second ID information and the second Internet-address information with the NAT-T signal server via the second NAT-T sub-module;
obtaining, by the first NAT-T sub-module, the second Internet-address information from the NAT-T signal server according to the second ID information; and
establishing, by the first NAT-T sub-module, the transmission channel with the second NAT-T sub-module according to the second Internet-address information after obtaining the second Internet-address information.

17. The non-transitory computer-readable storage medium as claimed in claim 15, wherein the step of detecting the transmission channel and the data packet by the first reliable transmission sub-module and the second reliable transmission sub-module further comprises the steps:
detecting, by a packet retransmission sub-module, whether the data packet is lost, and retransmitting the data packet when the data packet is lost;
detecting, by a traffic congestion control sub-module, a network performance of the transmission channel; wherein the network performance is a number of transmitting data packets, when the number of transmitting the data packets in the network exceeds a threshold, the traffic congestion control sub-module decreases a transmission rate of transmitting the data packets and reduces the number of data packets to avoid network congestion; and
detecting, by a packet ordering control sub-module, whether a receiving sequence of the data packets is consistent with a transmitting sequence of the data packets; when detecting the receiving sequence of the data packets is not consistent with the transmitting sequence of the data packets, the packet ordering control sub-module adjusts the transmitting sequence so that it is consistent with the receiving sequence.

18. The non-transitory computer-readable storage medium as claimed in claim 15, further comprising:
forwarding, by a virtual TCP server sub-module of the TCP server proxy module, the data packet between the first reliable transmission sub-module and the client module; and
forwarding, by a virtual TCP client sub-module of the TCP client proxy module, the data packet between the second reliable transmission sub-module and the server module.

19. The non-transitory computer-readable storage medium as claimed in claim 15, further comprising:
connecting, by a first router, the client with the network; and
connecting, by a second router, the server with the network.

20. The non-transitory computer-readable storage medium as claimed in claim 15, wherein the data packet is a TCP data packet.

21. The non-transitory computer-readable storage medium as claimed in claim 15, wherein the system supports TCP.
